(19) United States
(12) Patent Application Publication
(10) Pub. No.: US 2021/0325180 A1
(43) Pub. Date: Oct. 21, 2021

(54) SENSOR SWITCH

(71) Applicant: Tien-Ming CHOU, Taichung City (TW)

(72) Inventor: Tien-Ming CHOU, Taichung City (TW)

(21) Appl. No.: 17/087,117

(22) Filed: Nov. 2, 2020

(30) Foreign Application Priority Data
Apr. 17, 2020 (TW) 109113066

(51) Int. Cl. G01C 9/06

(52) U.S. Cl. CPC G01C 9/06; G01C 2009/068

(57) ABSTRACT

A sensor switch includes a base unit having bottom, top and intermediate layer assemblies cooperating with each other to define a chamber. The intermediate layer assembly has an intermediate layer inner peripheral surface. A conducting unit includes a plurality of inner and outer conducting elements. Each inner conducting element has a first conducting section. The first conducting sections of the inner conducting elements are disposed on the intermediate layer inner peripheral surface in an angularly spaced apart manner. Each outer conducting element is connected to the first conducting section of a corresponding inner conducting element. A conductive member is rollably disposed in the chamber.

### CROSS REFERENCE TO RELATED APPLICATION

This application claims priority of Taiwanese Patent Application Number 109113066, filed on Apr. 17, 2020.

### FIELD

The disclosure relates to a switch device, more particularly to a sensor switch.

### BACKGROUND

Smart phones usually have a sensor switch to detect changes in the tilt angle thereof so as to achieve the desired orientation of the screen, or to switch to mute, etc.

Currently, an existing sensor switch includes two shells made of plastic and cooperatively defining a receiving space, a plurality of sensing elements made of metal and disposed in the receiving space, and a ball rollably disposed in the receiving space. The existing sensor switch uses a conducting relationship between the ball and the sensing elements to determine the change in the tilt angle thereof.

However, the size of the existing sensor switch is large, so that the size of the smart phone will also be limited. Further, assembling and wiring operations during manufacture of the existing sensor switch are complicated.

### SUMMARY

Therefore, an object of the present disclosure is to provide a sensor switch that can alleviate at least one of the drawbacks of the prior art.

According to one aspect of this disclosure, a sensor switch comprises a base unit, a conducting unit, and a conductive member.

The base unit is made from a plurality of raw ceramic blanks that are sintered after being stacked, and includes a bottom layer assembly, a top layer assembly opposite to the bottom layer assembly in a top-bottom direction, and an intermediate layer assembly connected between the bottom layer assembly and the top layer assembly and cooperating with the bottom layer assembly and the top layer assembly to define a chamber having an axis parallel to the top-bottom direction. The intermediate layer assembly has an intermediate layer inner peripheral surface surrounding an intermediate part of the chamber. One of the bottom layer assembly and the top layer assembly has a first mounting surface disposed on an outer side thereof and distal to the chamber.

The conducting unit is made of metal and includes a plurality of inner conducting elements and a plurality of outer conducting elements. Each inner conducting element has a first conducting section. The first conducting sections of the inner conducting elements are disposed on the intermediate layer inner peripheral surface in an angularly spaced apart manner. Each outer conducting element is connected to the first conducting section of a corresponding one of the inner conducting elements and has a mounting portion. The mounting portions of at least some of the outer conducting elements are disposed on the first mounting surface.

The conductive member is made of metal and is rollably disposed in the chamber. The conductive member contacts any two adjacent ones of the first conducting sections when the sensor switch is tilted.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a sensor switch according to the first embodiment of the present disclosure;

FIG. 2 is an exploded perspective view of the first embodiment;

FIG. 3 is a schematic top view of the first embodiment, but with a topmost raw ceramic blank removed for the sake of clarity;

FIG. 4 is a sectional view of the first embodiment taken along line IV-IV of FIG. 1;

FIG. 5 is a sectional view of the first embodiment taken along line V-V of FIG. 1;

FIG. 6 is an exploded perspective view of a sensor switch according to the second embodiment of the present disclosure;

FIG. 7 is a schematic top view of the first embodiment, but with a topmost raw ceramic blank removed for the sake of clarity;

. 8 is a perspective view of a sensor switch according to the third embodiment of the present disclosure;

FIG. 9 is an exploded perspective view of the third embodiment;

. 10 is a sectional view of the third embodiment taken along line X-X of FIG. 8;

FIG. 11 is a perspective view of a sensor switch according to the fourth embodiment of the present disclosure;

. 12 is an exploded perspective view of the fourth embodiment;

FIG. 13 is a sectional view of the fourth embodiment taken along line XIII-XIII of FIG. 11;

FIG. 14 is an exploded perspective view of a sensor switch according to the fifth embodiment of the present disclosure; and

FIG. 15 is an assembled sectional view of the fifth embodiment.

### DETAILED DESCRIPTION

Before the present disclosure is described in greater detail with reference to the accompanying embodiments, it should be noted herein that like elements are denoted by the same reference numerals throughout the disclosure.

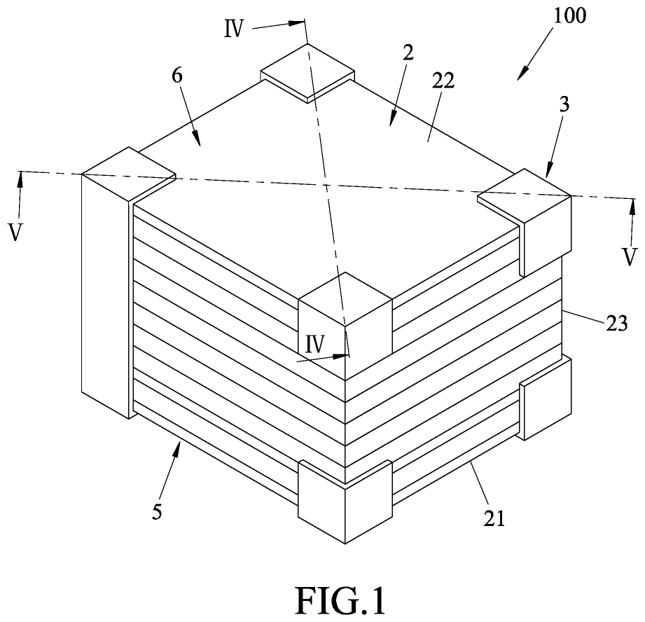

Referring to FIGS. 1 to 4, a sensor switch 100 according to the first embodiment of the present disclosure is suitable for connection with a circuit board (not shown), and includes a base unit 2, a conducting unit 3, and a conductive member 4.

The base unit 2 is made from a plurality of raw ceramic blanks 200 that are sintered after being stacked, and includes a bottom layer assembly 21, a top layer assembly 22 opposite to the bottom layer assembly 21 in a top-bottom direction (L), and an intermediate layer assembly 23 connected between the bottom layer assembly 21 and the top layer assembly 22. The bottom layer assembly 21, the intermediate layer assembly 23 and the top layer assembly 22 cooperatively define a chamber 24 having an axis (X) parallel to the top-bottom direction (L).

The bottom layer assembly 21 has a bottom layer inner peripheral surface 211 surrounding a bottom part 241 of the chamber 24, a bottom layer connecting surface 212, a bottom layer outer surface 213 opposite to the bottom layer connecting surface 212 and distal to the chamber 24, and a bottom layer outer peripheral surface 214 interconnecting peripheries of the bottom layer connecting surface 212 and the bottom layer outer surface 213.

The top layer assembly 22 has a top layer inner peripheral surface 221 surrounding a top part 242 of the chamber 24, a top layer connecting surface 222, a top layer outer surface 223 opposite to the top layer connecting surface 222 and distal to the chamber 24, and a top layer outer peripheral surface 224 interconnecting peripheries of the top layer connecting surface 222 and the top layer outer surface 223. In this embodiment, the bottom layer outer surface 213 serves as a first mounting surface 5, and the top layer outer surface 223 serves as a second mounting surface 6. The circuit board can be selectively mounted on one of the first and second mounting surfaces 5, 6.

The intermediate layer assembly 23 has an intermediate layer inner peripheral surface 231 surrounding an intermediate part 243 of the chamber 24, an intermediate layer first connecting surface 232 connected to the bottom layer connecting surface 212, an intermediate layer second connecting surface 233 opposite to the intermediate layer first connecting surface 232 and connected to the top layer connecting surface 222, and an intermediate layer outer peripheral surface 234 interconnecting peripheries of the intermediate layer first and second connecting surfaces 232, 233. The intermediate layer inner peripheral surface 231 is formed with a plurality of slots 2311 that are angularly spaced apart from each other, that extend along the axis (X), and that communicate with the intermediate part 243. In this embodiment, the number of the slots 2311 is four.

In this embodiment, the bottom layer assembly 21 consists of two raw ceramic blanks 200, the top layer assembly 22 consists of two raw ceramic blanks 200, and the intermediate layer assembly 23 consists of seven raw ceramic blanks 200, but are not limited thereto. Each raw ceramic blank 200 is made of inorganic ceramics. It should be noted herein that corresponding raw ceramic blanks 200 are integrated as one body after sintering.

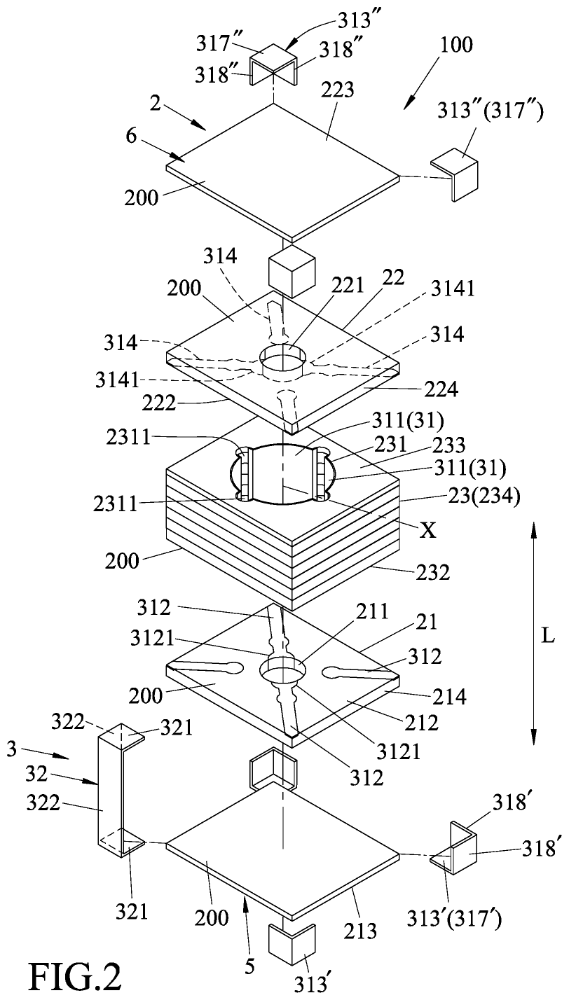

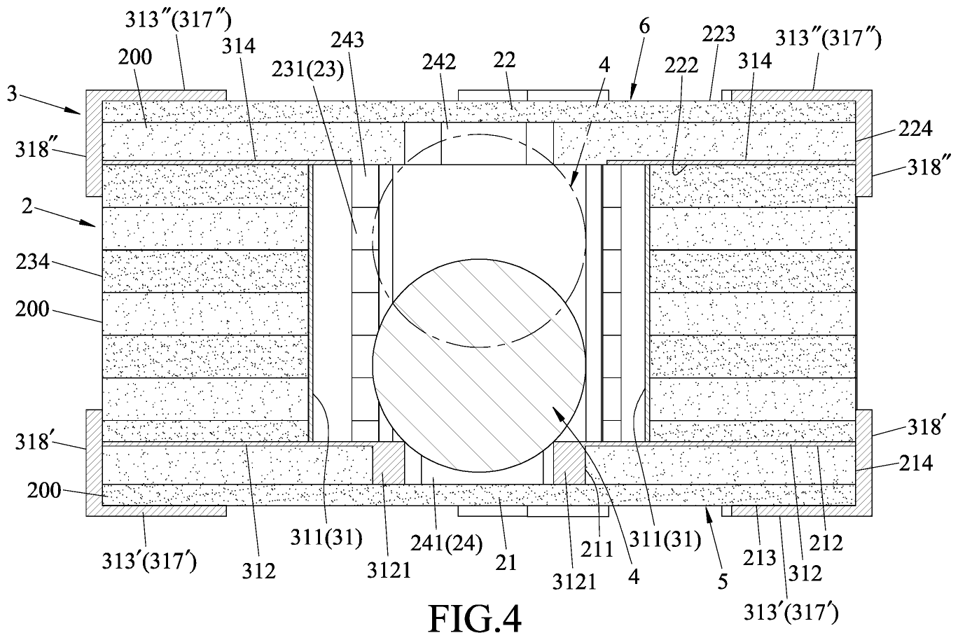

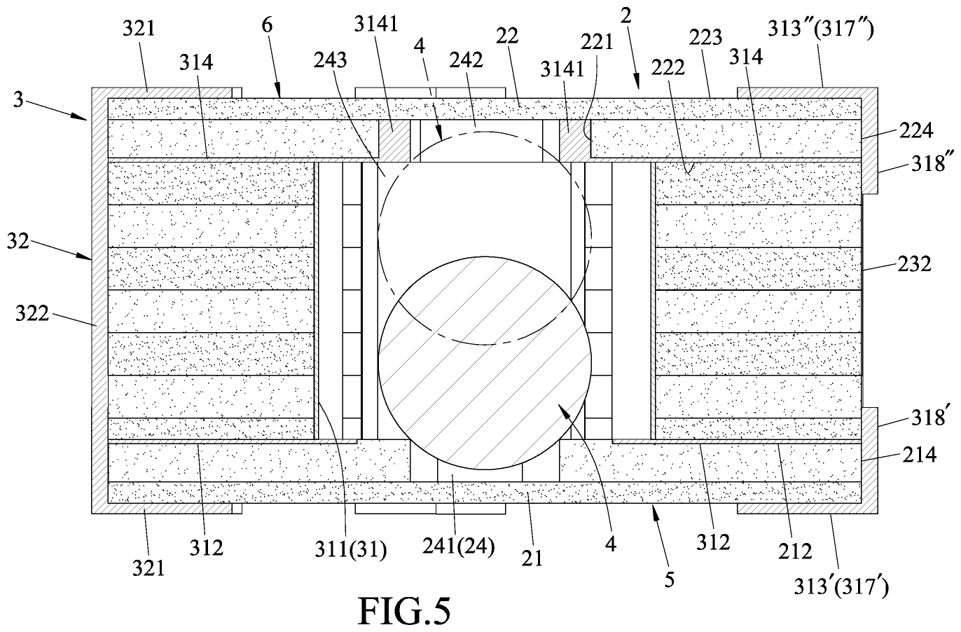

Referring to FIG. 5, in combination with FIGS. 2 and 4, the conducting unit 3 is made of metal, is disposed on the base unit 2, and includes four inner conducting elements 31, a plurality of outer conducting elements 313′, 313″, and a positioning conductive element 32.

Each inner conducting element 31 has a first conducting section 311, a second conducting section 312, and a third conducting section 314. The first conducting sections 311 of the inner conducting elements 31 are disposed on the intermediate layer inner peripheral surface 231 in an angularly spaced apart manner. Each first conducting section 311 is located between two adjacent ones of the slots 2311.

The second conducting sections 312 of the inner conducting elements 31 are disposed on the bottom layer connecting surface 212 in an angularly spaced apart manner. The second conducting section 312 of each inner conducting element 31 has an inner end connected to a bottom end of the first conducting section 311 of a respective one of the inner conducting elements 31. The second conducting sections 312 of two of the inner conducting elements 31, which are diagonally opposite to each other, further have second conducting extension portions 3121 extending from the inner ends thereof into the bottom layer inner peripheral surface 211.

The third conducting sections 314 of the inner conducting elements 31 are disposed on the top layer connecting surface 222 in an angularly spaced apart manner, and are staggered with the second conducting sections 312. The third conducting section 314 of each inner conducting element 31 has an inner end connected to a top end of the first conducting section 311 of the respective one of the inner conducting elements 31. The third conducting sections 314 of a third one and a fourth one of the inner conducting elements 31, which are diagonally opposite to each other, further have third conducting extension portions 3141 extending from the inner ends thereof into the top layer inner peripheral surface 221. Thus, the two of the inner conducting elements 31 have the second conducting extension portions 3121, but have no third conducting extension portions; while the third one and the fourth one of the inner conducting elements 31 have third conducting extension portions 3141, but have no second conducting extension portions.

The outer conducting elements 313′, 313″ are configured as corner connectors disposed on the corners of the base unit 2. In this embodiment, there are six outer conducting elements, that is, three outer conducting elements 313′ and three outer conducting elements 313″. The three outer conducting elements 313′ are disposed on three lower corners of the base unit 2. Each outer conducting element 313′ has a mounting portion 317′ mounted on and abutting against the bottom layer outer surface 213, and two side portions 318′ perpendicularly connected to each other and having bottom ends respectively connected to two adjacent lateral ends of the mounting portion 317′ such that each outer conducting element 313′ has a cubic shape. The side portions 318′ of each outer conducting element 313′ abut against the bottom layer outer peripheral surface 214 and a portion of the intermediate layer outer peripheral surface 234. The side portions 318′ of two of the outer conducting elements 313′ are connected to outer ends of the second conducting sections 312 of the two inner conducting elements 31 which have the second conducting extension portions 3121. The side portions 318′ of a third outer conducting element 313′ are connected to an outer end of the second conducting section 312 of the third inner conducting element 31.

The three outer conducting elements 313″ are disposed on three upper corners of the base unit 2, and are spaced apart from the outer conducting elements 313′ in the top-bottom. direction (L). Each outer conducting element 313″ has a mounting portion 317″ mounted on and abutting against the top layer outer surface 223, and two side portions 318″ perpendicularly connected to each other and having top ends respectively connected to two adjacent lateral ends of the mounting portion 317″ such that each outer conducting element 313″ also has a cubic shape. The side portions 318″ abut against the top layer outer peripheral surface 224 and a portion of the intermediate layer outer peripheral surface 234. The side portions 318″ of two of the outer conducting elements 313″ are connected to outer ends of the third conducting sections 314 of the two inner conducting elements 31 which have no third conducting extension portions. The side portions 318″ of a third outer conducting element 313″ are connected to an outer end of the third conducting section 314 of the third inner conducting element 31.

The positioning conductive element 32 extends from a fourth lower corner to a fourth upper corner of the base unit 2 in the top-bottom direction (L), and is spaced apart from the outer conducting elements 313′, 313″. The positioning conductive element 32 has two mounting portions 321 opposite to each other in the top-bottom direction (L) and respectively mounted on and abutting against the bottom layer outer surface 213 and the top layer outer surface 223, and two side portions 322 perpendicularly connected to each other. The side portions 322 have top ends respectively connected to two adjacent lateral ends of one of the mounting portions 321, and bottom ends respectively connected to two adjacent lateral ends of the other mounting portion 321 such that the positioning conductive element 32 has a cubic shape. The side portions 322 are connected to outer ends of the second conducting section 312 and the third conducting section 314 of the fourth inner conducting element 31. It should be noted herein that the positioning conductive element 32 may also serve to indicate the top-bottom direction of the base unit 2 so as to facilitate mounting of the circuit board to the first or second mounting surface 5, 6.

Through the presence of the second conducting sections 312 and the third conducting sections 314 of the inner conducting elements 31, the outer conducting elements 313′ and 313″ and the positioning conducting element 32 can be connected to the first conducting sections 311 of the inner conducting elements 31.

conductive member 4 is made of metal and is rollably disposed in the chamber 24. In this embodiment, the conductive member 4 is a spherical ball having a diameter larger than a diameter of each of the bottom layer inner peripheral surface 211 and the top layer inner peripheral surface 221, but smaller than a diameter of the intermediate layer inner peripheral surface 231. Each slot 2311 has a width smaller than the diameter of the conductive member 4. When the conductive member 4 is located on the intermediate part 243 of the chamber 24, the conductive member 4 can simultaneously contact the first conducting sections 311 of two adjacent ones of the inner conducting elements 31.

A manufacturing process of the sensor switch 100 of this disclosure involves the following steps:

Step 1: forming corresponding holes in the raw ceramic blanks 200 by machining;

Step 2: disposing metal materials (such as silver, copper, gold, etc.) on the raw ceramic blanks 200 at positions corresponding to the first conducting sections 311, the second conducting sections 312 and the third conducting sections 314 of the inner conducting elements 31, the technological method of disposing the metal materials on the raw ceramic blanks 200 may include applying conductive adhesive to a stencil, a steel plate, or ink jet, or by electroplating, chemical plating, sputtering, or using at least two of the above mentioned methods;

Step 3: stacking the raw ceramic blanks 200 one above the other, and applying equal pressure on the stacked raw ceramic blanks 200 to achieve a compact arrangement;

Step 4: cutting the compact stacked raw ceramic blanks 200 to a desired size;

Step 5: electroplating, sputtering or coating the metal materials (such as gold, alloy, etc.) disposed on the raw ceramic blanks 200 at positions corresponding to the first conducting sections 311, the second conducting sections 312 and the third conducting sections 314 of the inner conducting elements 31 according to the requirement;

Step 6: using a slow heating rate to increase the ambient temperature to burn and crack the polymer additives added to the raw ceramic blanks 200 during pulping, then the temperature is raised to densify the raw ceramic blanks to remove holes, and sintering the raw ceramic blanks 200 to form the bottom layer assembly 21, the top layer assembly 22 and the intermediate layer assembly 23, and connecting the metal materials in Step 2 to form the first conducting sections 311, the second conducting sections 312 and the third conducting sections 314 of the inner conducting elements 31;

Step 7: placing the conductive member 4 in the chamber 24 and then coating adhesive materials (such as resin, glass, etc.) on a junction of the top layer assembly 22 and the intermediate layer assembly 23 and a junction of the bottom layer assembly 21 and the intermediate layer assembly 23, after which the ambient temperature is raised, and the top layer assembly 22, the bottom layer assembly 21 and the intermediate layer assembly 23 are pressed and adhered together to form the base unit 2;

Step 8: disposing metal materials (such as silver, copper, gold, etc.) by electroplating, sputtering or coating on corresponding positions of the base unit 2 to form the outer conducting elements 313′, 313″ and the positioning conductive element 32, and densifying the outer conducting elements 313′, 313″ and the positioning conductive element 32, so that the outer conducting elements 313′, 313″ and the positioning conductive element 32 are connected to the corners of the base unit 2 and have good conductivity.

Through the aforesaid Steps 1 to 8, the sensor switch 100 can be completed.

In use, the circuit board may be disposed on the first mounting surface 5 or the second mounting surface 6 according to the requirement. The mounting portions 317′ of the outer conducting elements 313′ and the mounting portion 321 of the positioning conductive element 32 mounted on the bottom layer outer surface 213 are electrically connected to the circuit board when the circuit board is disposed on the first mounting surface 5. The mounting portions 317″ of the outer conducting elements 313″ and the mounting portion 321 of the positioning conductive element 32 mounted on the top layer outer surface 223 are electrically connected to the circuit board when the circuit board is disposed on the second mounting surface 6.

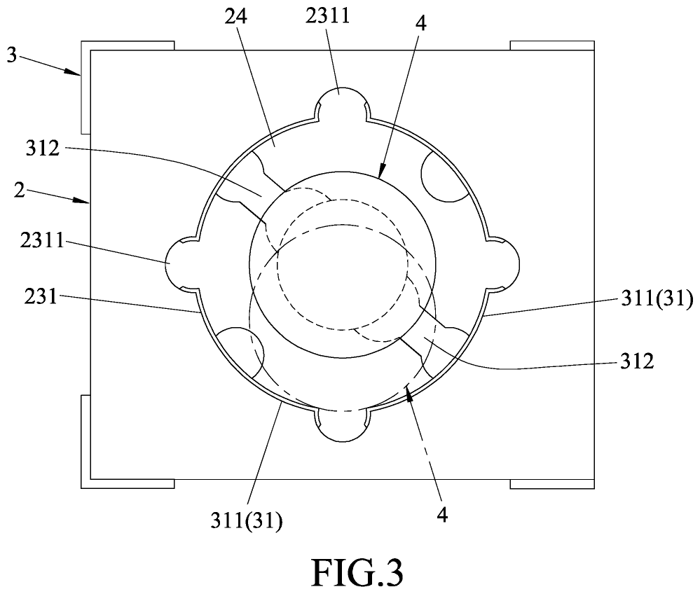

With reference to FIGS. 3 to 5, when the sensor switch 100 is tilted, the conductive member 4 is rolled by gravity to contact the first conducting sections 311 of any two adjacent ones of the inner conducting elements 31. When the sensor switch 100 is placed in a horizontal position and the bottom layer outer surface 213 faces downward, the conductive member 4, as shown in solid lines in FIGS. 4 and 5, is rolled toward the bottom part 241 of the chamber 24 to contact and connect with the second conducting extension portions 3121 of the two inner conducting elements 31. When the sensor switch 100 is rotated until the top layer outer surface 223 faces downward, the conductive member 4, as shown in imaginary lines in FIGS. 4 and 5, is rolled toward the top part 242 of the chamber 24 to contact and connect with the third conducting extension portions 3141 of the third and fourth inner conducting elements 31. When the sensor switch 100 is tilted, the conductive member 4, as shown in imaginary line in FIG. 3, is rolled within the intermediate part 243 of the chamber 24 to contact and connect with the first conducting sections 311 of two adjacent ones of the inner conducting elements 31.

With reference to FIGS. 2 to 4, since the first conducting sections 311 of the inner conducting elements 31 are angularly spaced apart from each other on the intermediate layer inner peripheral surface 231 and surround the axis (X), and since the second conducting extension portions 3121 and the third conducting extension portions 3141 are staggered with respect to each other, when the conductive member 4 contacts the first conducting sections 311 of two adjacent inner conducting elements 31, it can be determined that the conductive member 4 is located in the intermediate part 243 of the chamber 24 and the sensor switch 100 is in a tilted position; and when the conductive member 4 rolls to contact the second conducting extension portions 3121 or the third conducting extension portions 3141, it can be determined that the conductive member 4 is located in the bottom layer inner peripheral surface 211 or the top layer inner peripheral surface 221. In this case, the sensor switch 100 can be used as a six-face vibration switch.

Thus, by sintering the raw ceramic blanks 200 to make the base unit 2 of the sensor switch 100, and by using the method of stencil, steel plate, ink jet, electroplating, chemical plating or sputtering to form the first conducting sections 311 and the second and third conducting sections 312, 314 of the inner conducting elements 31, the volume of the sensor switch 100 can be effectively reduced, so that the sensor switch 100 can be applied to smaller products, and the steps of assembly and wiring can be simplified.

It is worth to mention herein that, in this embodiment, since the diameter of the conductive member 4 is larger than the diameter of each of the bottom and top layer inner peripheral surfaces 211, 221, but smaller than the diameter of the intermediate layer inner peripheral surface 231, the conductive member 4 can freely roll within the intermediate part 243 of the chamber 24. When the conductive member 4 rolls to the top part 242 or bottom part 241 of the chamber 24, the bottom or top layer inner peripheral surface 211, 221 can provide support to the conductive member 4 to stay there, but not to the point that will make the conductive member 4 unable to roll.

Further, by adjusting the proportion of the diameter of each of the bottom and top layer inner peripheral surfaces 211, 221 with the diameter of the conductive member 4, the sensor switch 100 can be used as an angle switch. When the sensor switch 100 is used as an angle switch, there is no need to provide the second conducting extension portions 3121 or the third conducting extension portions 3141.

It should be noted that, in this embodiment, the width of each slot 2311 is smaller than the diameter of the conductive member 4, so that the conductive member 4 is prevented from being stuck in each slot 2311. Further, when the conductive member 4, as shown in imaginary line in FIG. 3, rolls to a corresponding one of the slots 2311, the intermediate layer inner peripheral surface 231 can provide support to the conductive member 4 to stay there, but not to the point that will make the conductive member 4 unable to roll. When the sensor switch 100 is rotated about the axis (X), the conductive member 4 can move away from the corresponding slot 2311.

It is worth to mention herein that, in this embodiment, through the provision of the second conducting sections 312 and the third conducting sections 314, the circuit board can be disposed on the first or second mounting surface 5, 6, so that the sensor switch 100 can be applied to different sizes and shapes of products (not shown). However, in other implementation of this embodiment, only the second conducting portions 312 may be provided on the bottom layer assembly 21, and the circuit board is disposed on the first mounting surface 5.

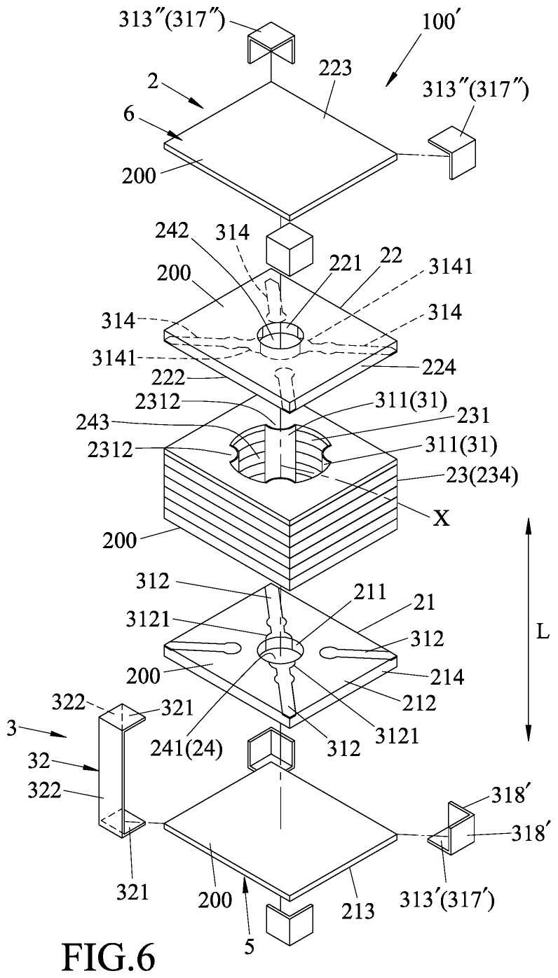

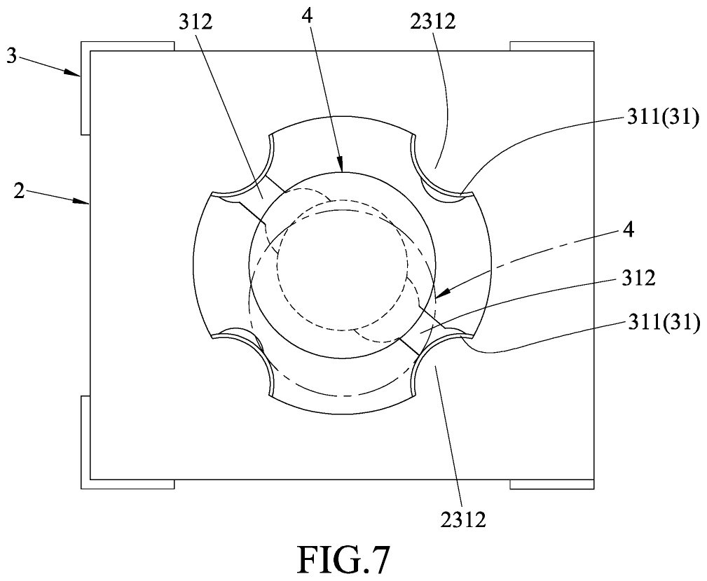

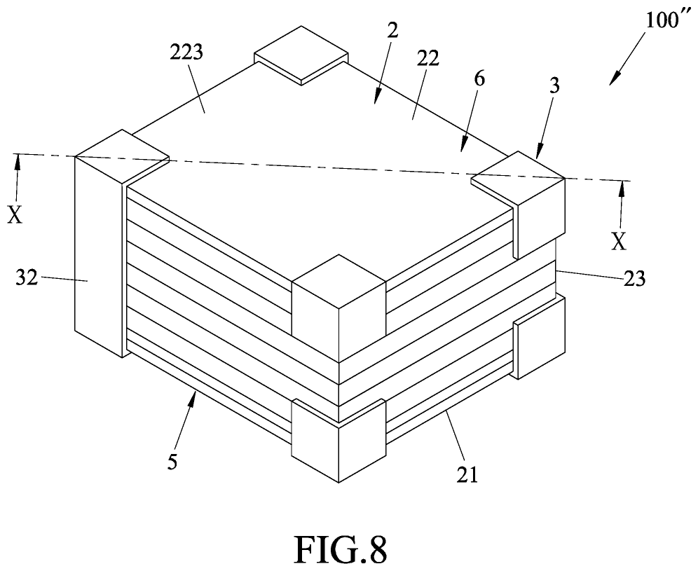

Referring to FIGS. 6 and 7, the second embodiment of the sensor switch 100′ according to this disclosure is shown to be similar to the first embodiment. The second embodiment differs from the first embodiment in that the intermediate layer inner peripheral surface 231 is formed with a plurality of protrusions 2312 angularly spaced apart from each other and extending along the axis (X), and each of the first conducting sections 311 of the inner conducting elements 31 is disposed on a respective one of the protrusions 2312.

In this embodiment, the number of the protrusion 2312 is four. A distance between each two adjacent ones of the protrusions 2312 is smaller than the diameter of the conductive member 4, so that the conductive member 4 can be prevented from being stuck between each two adjacent ones of the protrusions 2312. Further, through the provision of the protrusions 2312, when the conductive member 4, as shown in imaginary line in FIG. 7, rolls to two adjacent ones of the protrusions 2312, the intermediate layer inner peripheral surface 231 can provide support to the conductive member 4 to stay there, but not to the point that will make the conductive member 4 unable to roll. When the sensor switch 100′ is rotated about the axis (X), the conductive member 4 can move away from the two adjacent ones of the protrusions 2312. The purpose and effect of the first embodiment can be similarly achieved using the second embodiment.

Referring to FIGS. 8 to 10, the third embodiment of the sensor switch 100″ according to this disclosure is shown to be similar to the second embodiment. However, in this embodiment, the intermediate layer assembly 23 includes a bottom connecting portion 26 and a top connecting portion 27, and the diameter of each of the bottom and top layer inner peripheral surfaces 211, 221 is similar to the diameter of the intermediate layer inner peripheral surface 231.

The bottom connecting portion 26 is adjacent to the bottom layer assembly 21, and consists of two raw ceramic blanks 200, but is not limited thereto. The bottom connecting potion 26 has an inner peripheral surface 261, an outer peripheral surface 262 opposite to the inner peripheral surface 261, a first connecting surface 263 connected to the bottom layer connecting surface 212, and a second connecting surface 263′ opposite to the first connecting surface 263 in the top-bottom direction (L).

The top connecting portion 27 is adjacent to the top layer assembly 22, and consists of three raw ceramic blanks 200, but is not limited thereto. The top connecting portion 27 has an inner peripheral surface 271, an outer peripheral surface 272 opposite to the inner peripheral surface 271, a first connecting surface 273 adjacent to the second connecting surface 263′ of the bottom connecting portion 26, and a second connecting surface 273′ connected to the top layer connecting surface 222.

The inner peripheral surfaces 261, 271 of the bottom and top connecting portions 26, 27 constitute the intermediate layer inner peripheral surface 231, while the outer peripheral surfaces 262, 272 of the bottom and top connecting portions 26, 27 constitute the intermediate layer outer peripheral surface 234.

The first conducting section 311 of each inner conducting element 31 extends from the bottom layer inner peripheral surface 211 to the top layer inner peripheral surface 221, as shown in FIG. 10.

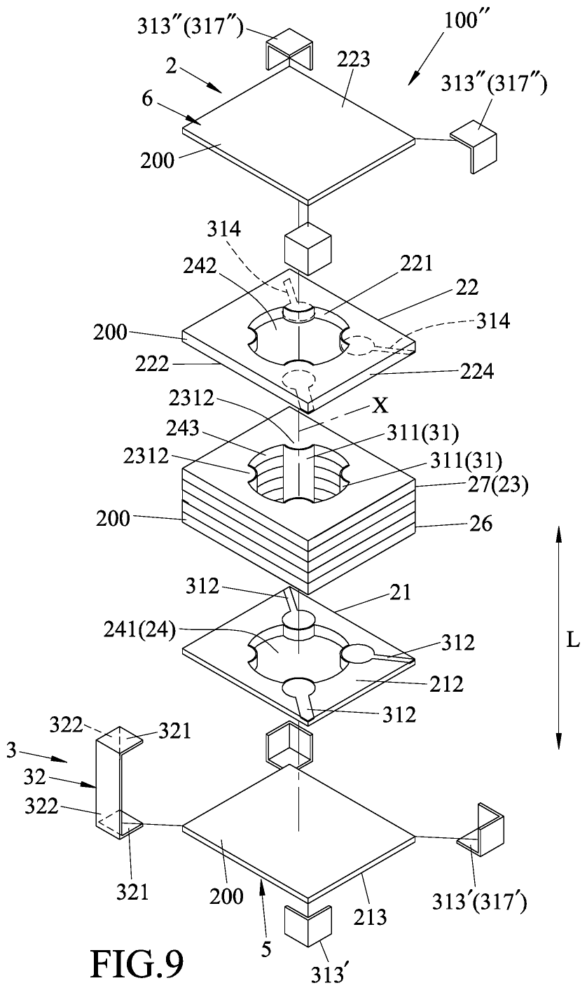

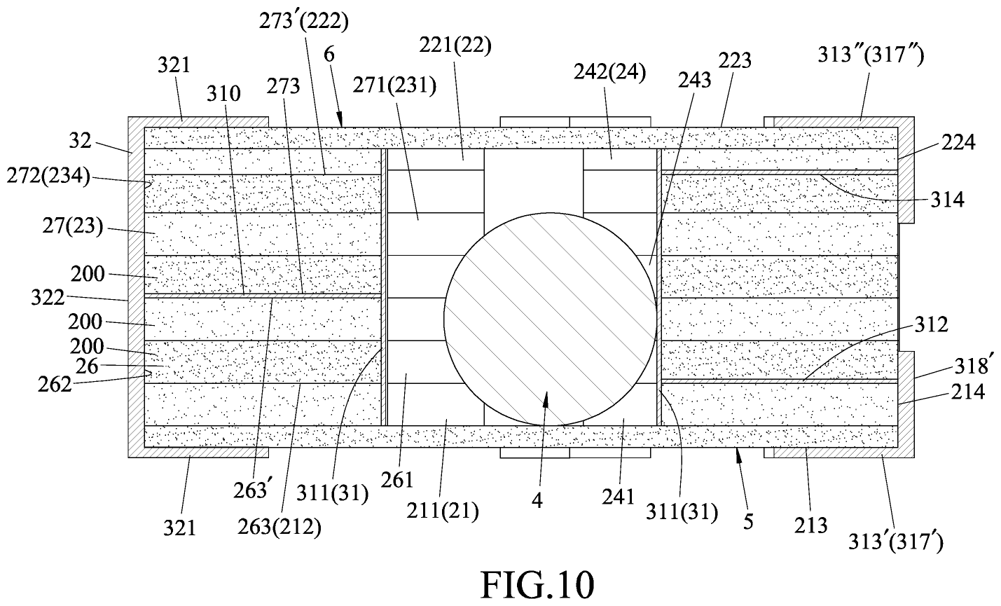

With reference to FIGS. 9 and 10, the fourth inner conducting element 31 of this embodiment only has the first conducting section 311, but further has a connecting section 310 disposed between the second connecting surface 263′ of the bottom connecting portion 26 and the first connecting surface 273 of the top connecting portion 27 and connected between the first conducting section 311 of the fourth inner conducting element 31 and the side portions 322 of the positioning conductive element 32. The manufacturing process of the connecting section 310 is similar to that of the second or third conducting section 312, 314, so that a detailed description thereof is omitted herein.

Since the connecting section 310 is connected between the first conducting section 311 of the fourth inner conducting element 31 and the side portions 322 of the positioning conductive element 32, and the positioning conductive element 32 has the two mounting portions 321 respectively mounted on and abutting against the bottom layer outer surface 213 and the top layer outer surface 223, electric current can flow through the positioning conductive element 32 and the connecting section 310 to the first conducting section 311 of the fourth inner conducting element 31. Hence, there is no need to provide the second and third conducting sections 312, 314 to the fourth inner conducting element 31 for connection with the positioning conductive element 32, and the effect of conducting current can also be achieved.

In this embodiment, the conductive member 4 has a diameter smaller than that of each of the bottom, top and intermediate layer inner peripheral surfaces 211, 221, 231.

When the conductive member 4 contacts the first conducting sections 311 of two adjacent inner conducting elements 31, the tilted position of the sensor switch 100″ can be determined. Hence, the sensor switch 100″ can be used as a four-sided sensor switch.

Moreover, in this embodiment, the connecting section 310 is disposed between the second connecting surface 263′ of the bottom connecting portion 26 and the first connecting surface 273 of the top connecting portion 27, but is not limited thereto. The connecting section 310 may be disposed on any one of the raw ceramic blanks 200, and as long as the connecting section 310 is connected between the first conducting section 311 and the positioning conductive element 32, any disposition of the connecting section 310 is acceptable. The purpose and effect of the second embodiment can be similarly achieved using the third embodiment.

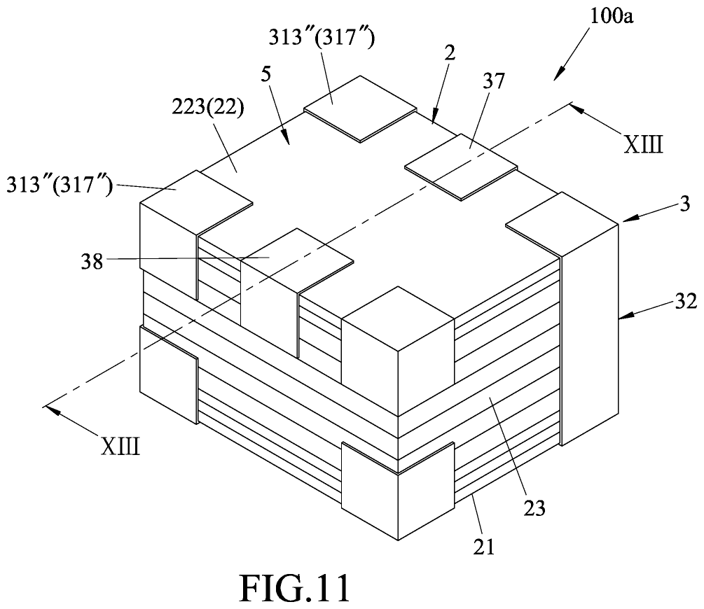

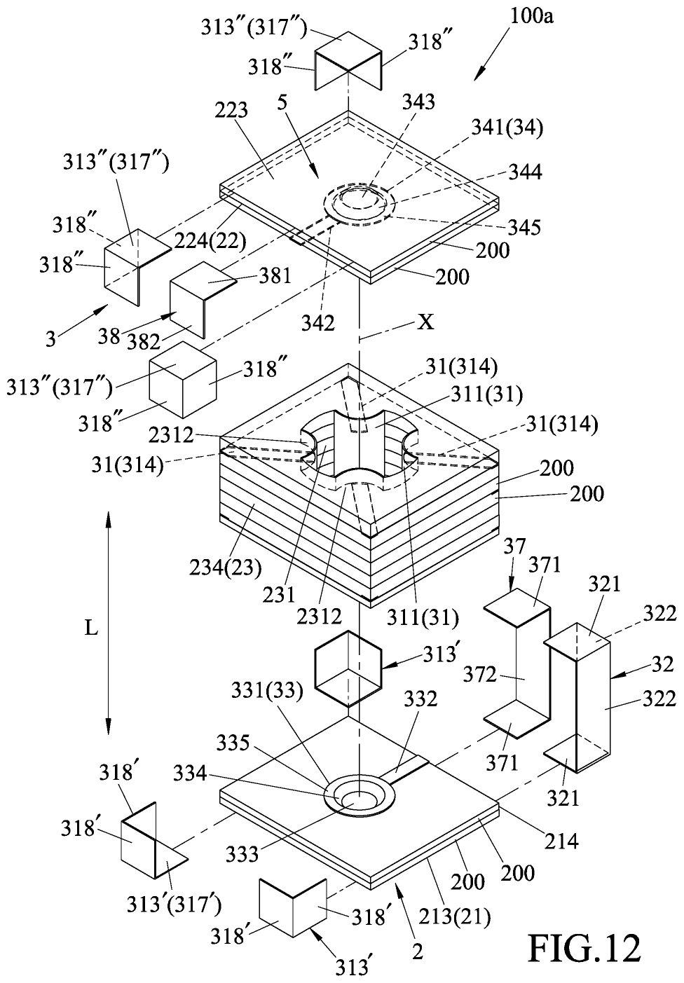

Referring to FIGS. 11 to 13, the fourth embodiment of the sensor switch (100a) according to this disclosure is shown to be similar to the second embodiment. However, in this embodiment, the top layer outer surface 223 serves as the first mounting surface 5, the second conducting section (not visible) of each inner conducting element 31 is disposed between two adjacent raw ceramic blanks 200 of the intermediate layer assembly 23 which are proximate to a bottom side thereof, and the third conducting section 314 of each inner conducting element 31 is disposed between two adjacent raw ceramic blanks 200 of the intermediate layer assembly 23 which are proximate to a top side thereof.

The inner ends of the second and third conducting sections 314 of the inner conducting elements 31 are connected to the first conducting sections 311 thereof. The outer ends of the second conducting sections of the inner conducting elements 31 are connected to the side portions 318′, 322 of the outer conducting elements 313′ and the positioning conductive element 32. The outer ends of the third conducting sections 314 of the inner conducting elements 31 are connected to the side portions 318″, 322 of the outer conducting elements 313″ and the positioning conductive element 32.

The conducting unit 3 further includes a U-shaped conductive element 37, an L-shaped conductive element 38, a lower sensing element 33, and an upper sensing element 34.

The U-shaped conductive element 37 is disposed between the positioning conductive element 32 and one of the outer conducting elements 313′ and a corresponding one of the outer conducting elements 313″. The U-shaped conductive element 37 has two mounting portions 371 spaced apart from each other in the top-bottom direction (L) and respectively mounted on the first mounting surface 5 and the bottom layer outer surface 213, and an intermediate portion 372 connected between the mounting portions 371 and abutting against the bottom layer outer peripheral surface 214, the intermediate layer outer peripheral surface 234 and the top layer outer peripheral surface 224.

The L-shaped conductive element 38 is disposed between two adjacent outer conducting elements 313″, and has a horizontal portion 381 mounted on the first mounting surface 5, and a vertical portion 382 extending downwardly from one end of the horizontal portion 381 and abutting against the top layer outer peripheral surface 224 and a portion of the intermediate layer outer peripheral surface 234.

The lower sensing element 33 has a lower main portion 331 disposed on the bottom layer inner peripheral surface 211 or the bottom part 241 of the chamber 24, and a lower connecting portion 332 connected between the lower main portion 331 and the intermediate portion 372 of the U-shaped conductive element 37. The lower main portion 331 has a lower main wall 333 transverse to the axis (X) , a lower surrounding wall 334 extending upwardly and inclinedly from a periphery of the lower main wall 333 away from the axis (X), and a lower extension wall 335 extending outwardly and radially from the lower surrounding wall 334 at one end thereof that is opposite to the lower main wall 333. In this embodiment, an angle between the lower surrounding wall 334 and the lower main wall 333 is 45 degrees, but is not limited thereto.

The upper sensing element 34 has an upper main portion 341 disposed on the top layer inner peripheral surface 221 or the top part 242 of the chamber 24, and an upper connecting portion 342 connected between the upper main portion 341 and the vertical portion 382 of the L-shaped conductive element 38. The upper main portion 341 has an upper main wall 343 transverse to the axis (X), an upper surrounding wall 344 extending upwardly and inclinedly from a periphery of the upper main wall 343 away from the axis (X), and an upper extension wall 345 extending outwardly and radially from the upper surrounding wall 344 at one end thereof that is opposite to the upper main wall 343. In this embodiment, an angle between the upper surrounding wall 344 and the upper main wall 343 is 45 degrees, but is not limited thereto.

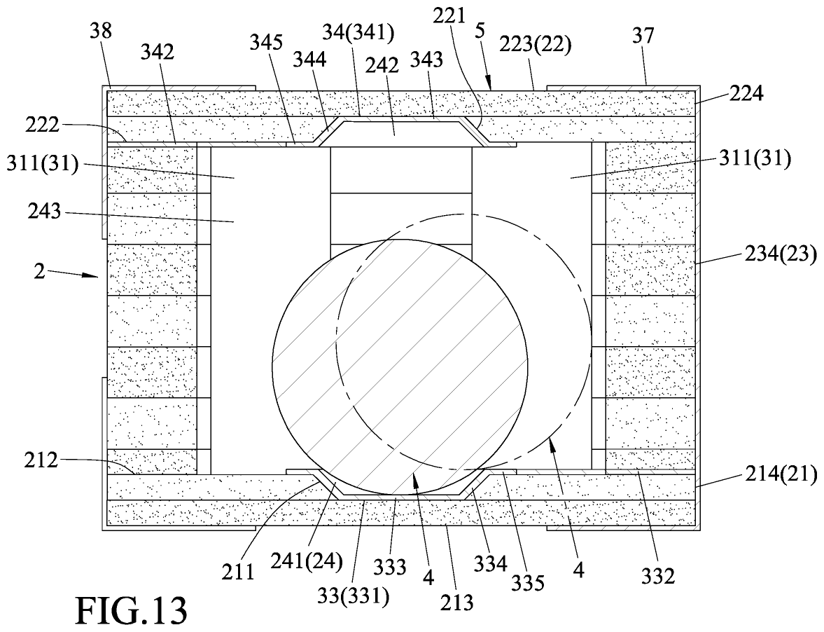

When the circuit board is disposed on the first mounting surface 5, the circuit board is electrically connected to the mounting portions 317 of the outer conducting elements 313″, one of the mounting portions 321 of the positioning conductive element 32, one of the mounting portions 371 of the U-shaped conductive element 37, and the horizontal portion 381 of the L-shaped conductive element 38. Through this, whether or not the conductive member 4 is in contact with the first conducting sections 311 of the inner conducting elements 313, the lower main portion 331 or the upper main portion 341 can be determined, so that a tilting direction of the sensor switch (100a) can also be determined. For example, when the sensor switch (100a) is in a horizontal position and the bottom layer outer surface 213 faces downward, the conductive member 4, as shown in solid line in FIG. 13, only contacts the lower main portion 331, so that the circuit is open at this time. When the sensor switch (100a) is tilted, the conductive member 4, as shown in imaginary line in FIG. 13, rolls to contact the first conducting sections 311 of two adjacent ones of the inner conducting elements 31 and the lower main portion 331, so that the circuit is closed at this time.

Further, through the provision of the lower main portion 331 and the upper main portion 341, when the conductive member 4 rolls to the lower main wall 333 or the upper main wall 343, the lower surrounding wall 334 or the upper surrounding wall 344 can provide support to the conductive member 4 to stay on the lower main wall 333 or the upper main wall 343, but not to the point that will make the conductive member 4 unable to roll. In this embodiment, when the sensor switch (100a) is rotated 45 degrees about the axis (X), the conductive member 4 can move away from the lower main wall 333 or the upper main wall 343.

It is worth to mention herein that, in this embodiment, the lower connecting portion 332 is disposed on the bottom layer connecting surface 212 and is connected to the lower extension wall 335, but is not limited thereto. The lower connecting portion 332 maybe connected to the lower main wall 333 or the lower surrounding wall 334, and may extend between two adjacent raw ceramic blanks 200 of the bottom layer assembly 21 and connect with the U-shaped conductive element 37. Similarly, the upper connecting portion 342 maybe connected to the upper main wall 343 or the upper surrounding wall 344, and may extend between two adjacent raw ceramic blanks 200 of the top layer assembly 22 and connect with the L-shaped conductive element 38. The purpose and effect of the second embodiment can be similarly achieved using the fourth embodiment.

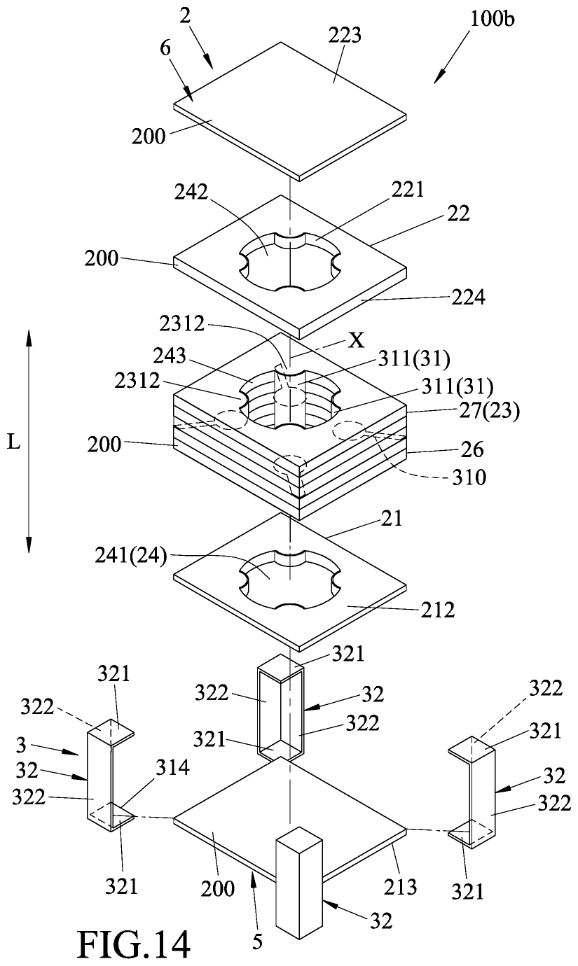

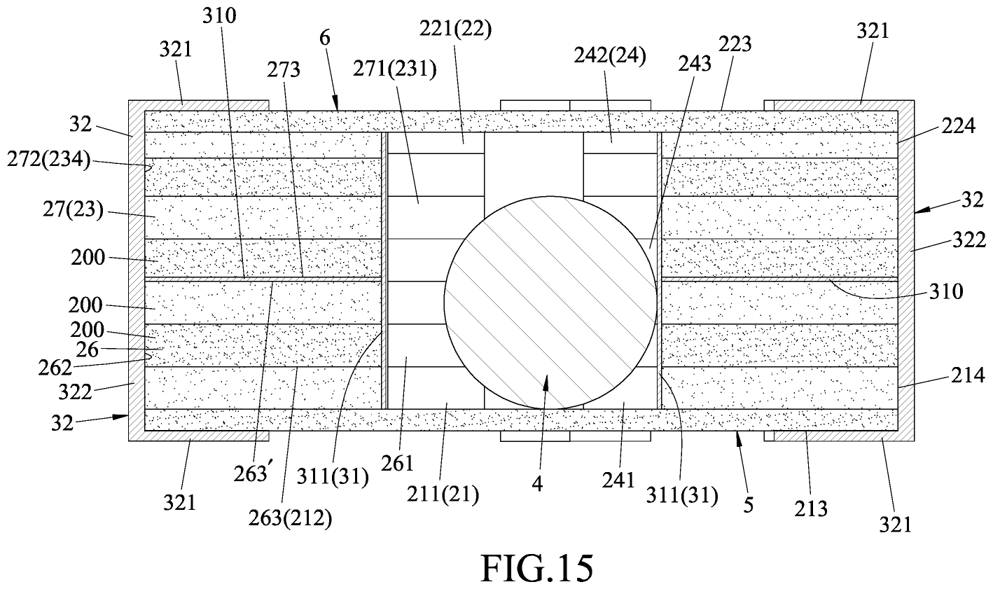

Referring to FIGS. 14 and 15, the fifth embodiment of the sensor switch (100b) according to this disclosure is shown to be similar to the third embodiment. Particularly, the intermediate layer assembly 23 includes a bottom connecting portion 26 and a top connecting portion 27, and the conductive member 4 has a diameter smaller than that of each of the bottom, top and intermediate layer inner peripheral surfaces 211, 221, 231. However, in this embodiment, the conducting unit 3 includes four positioning conductive elements 32 disposed on four corners of the base unit 2, so that the outer conducting elements 313′, 313″ (see FIG. 9) are dispensed herewith. Further, the second and third conducting sections 312, 314 of the inner conducting elements 31 are also dispensed herewith. Instead, each inner conducting element 31 is provided with a connecting section 310 disposed between the second connecting surface 263′ of the bottom connecting portion 26 and the first connecting surface 273 of the top connecting portion 27 and connected between the first conducting section 311 of one of the inner conducting elements 31 and the side portions 322 of a respective one of the positioning conductive elements 32. The purpose and effect of the third embodiment can be similarly achieved using the fifth embodiment.

In the description above, for the purposes of explanation, numerous specific details have been set forth in order to provide a thorough understanding of the embodiment(s). It will be apparent, however, to one skilled in the art, that one or more other embodiments maybe practiced without some of these specific details. It should also be appreciated that reference throughout this specification to “one embodiment,”“an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A sensor switch comprising:
a base unit made from a plurality of raw ceramic blanks that are sintered after being stacked, said base unit including a bottom layer assembly, a top layer assembly opposite to said bottom layer assembly in a top-bottom direction, and an inter-mediate layer assembly connected between said bottom layer assembly and said top layer assembly and cooperating with said bottom layer assembly and said top layer assembly to define a chamber having an axis parallel to the top-bottom direction, said intermediate layer assembly having an intermediate layer inner peripheral surface surrounding an intermediate part of said chamber, one of said bottom layer assembly and said top layer assembly having a first mounting surface disposed on an outer side thereof and distal to said chamber;
a conducting unit made of metal and including a plurality of inner conducting elements and a plurality of outer conducting elements, each of said inner conducting elements having a first conducting section, said first conducting sections of said inner conducting elements being disposed on said intermediate layer inner peripheral surface in an angularly spaced apart manner, each of said outer conducting elements being connected to said first conducting section of a corresponding one of said inner conducting elements and having a mounting portion said mounting portions of at least some of said outer conducting elements being disposed on said first mounting surface; and
a conductive member made of metal and rollably disposed in said chamber;
wherein said conductive member contacts any two adjacent ones of said first conducting sections when said sensor switch is tilted.

2. The sensor switch as claimed in claim 1, wherein said intermediate layer inner peripheral surface is formed with a plurality of slots that are angularly spaced apart from each other, that extend along the axis and that communicate with said intermediate part of said chamber, each of said first conducting sections being disposed between two adjacent ones of said slots.

3. The sensor switch as claimed in claim 1, wherein said intermediate layer inner peripheral surface is formed with a plurality of protrusions angularly spaced apart from each other and extending along the axis, each of said first conducting sections being disposed on a respective one of said protrusions.

4. The sensor switch as claimed in claim 1, wherein said bottom layer assembly has a bottom layer inner peripheral surface surrounding a bottom part of said chamber, and said top layer assembly has a top layer inner peripheral surface surrounding a top part of said chamber.

5. The sensor switch as claimed in claim 4, wherein said conductive member has a diameter larger than a diameter of each of said bottom layer inner peripheral surface and said top layer inner peripheral surface, but smaller than a diameter of said intermediate layer inner peripheral surface.

6. The sensor switch as claimed in claim 5, wherein:
said bottom layer assembly has said first mounting surface;
said top layer assembly has a second mounting surface disposed on an outer side thereof and opposite to said first mounting surface in the top-bottom direction;
each of said inner conducting elements further has a second conducting section and a third conducting section connected to a bottom end and a top end of said first conducting section thereof;
each of the at least some of said outer conducting elements is connected to said first conducting section of the corresponding one of said inner conducting elements through said second conducting section; and
each of the other ones of said outer conducting elements is connected to said first conducting section of the corresponding one of said inner conducting elements through said third conducting section, said mounting portions of the other ones of said outer conducting elements being located on said second mounting surface.

7. The sensor switch as claimed in claim 6, wherein:
said bottom layer assembly further has a bottom layer connecting surface connected to a bottom side of said intermediate layer assembly;
said top layer assembly further has a top layer connecting surface connected to a top side of said intermediate layer assembly;
said second conducting sections of said inner conducting elements are disposed on said bottom layer connecting surface; and
said third conducting sections of said inner conducting elements are disposed on said top layer connecting surface and are staggered with said second conducting sections.

8. The sensor switch as claimed in claim 5, wherein:
said top layer assembly has said first mounting surface; and
said conducting unit further includes
a U-shaped conductive element having two mounting portions respectively mounted on said first mounting surface and said outer side of said bottom layer assembly, and an intermediate portion connected between said two mounting portions,
an L-shaped conductive element having a horizontal portion mounted on said first mounting surface, and a vertical portion extending downwardly from one end of said horizontal portion,
a lower sensing element having a lower main portion disposed on said bottom layer inner peripheral surface, and a lower connecting portion connected between said lower main portion and said intermediate portion of said U-shaped conductive element, and
an upper sensing element having an upper main portion disposed on said top layer inner peripheral surface, and an upper connecting portion connected between said upper main portion and said vertical portion of said L-shaped conductive element.

9. The sensor switch as claimed in claim 8, wherein said lower main portion has a lower main wall transverse to the axis, and a lower surrounding wall extending upwardly and inclinedly from a periphery of said lower main wall away from the axis, said upper main portion having an upper main wall transverse to the axis, and an upper surrounding wall extending upwardly and inclinedly from a periphery of said upper main wall away from the axis.

10. The sensor switch as claimed in claim 4, wherein said conductive member has a diameter smaller than a diameter of each of said bottom layer inner peripheral surface, said top layer inner peripheral surface and said intermediate layer inner peripheral surface, each of said first conducting sections extending from said bottom layer inner peripheral surface to said top layer inner peripheral surface.

11. The sensor switch as claimed in claim 10, wherein:
said bottom layer assembly has said first mounting surface;
said top layer assembly has a second mounting surface disposed on an outer side thereof and opposite to said first mounting surface in the top-bottom direction;
said intermediate layer assembly includes a bottom connecting portion having a first connecting surface connected to said bottom layer assembly, and a second connecting surface opposite to said first connecting surface in the top-bottom direction; and
said intermediate layer assembly further includes a top connecting portion having a first connecting surface adjacent to said second connecting surface of said bottom connecting portion, and a second connecting surface connected to said top layer assembly.

12. The sensor switch as claimed in claim 11, wherein:
said conducting unit further includes a positioning conductive element spaced apart from said outer conducting elements and extending along the top-bottom direction; and
one of said inner conducting elements further has a connecting section disposed between said second connecting surface of said bottom connecting portion and said first connecting surface of said top connecting portion and connected between said first conducting section of one of said inner conducting elements and said positioning conductive element.

13. The sensor switch as claimed in claim 11, wherein:
said conducting unit further includes a plurality of spaced-apart positioning conductive elements extending along the top-bottom direction; and
each of said inner conducting elements further has a connecting section disposed between said second connecting surface of said bottom connecting portion and said first connecting surface of said top connecting portion and connected between said first conducting section of one of said inner conducting elements and a respective one of said positioning conductive elements.
